(19) United States
(12) Patent Application Publication
(10) Pub. No.: US 2012/0028658 A1
(43) Pub. Date: Feb. 2, 2012

(54) Communication system for exchange of messages at a facility

(76) Inventor: Jay Kelly, Oklahoma City, OK (US)

(21) Appl. No.: 12/804,876

(22) Filed: Jul. 29, 2010

(51) Int. Cl. H04W 4/12

(52) U.S. Cl. 455/466

(57) ABSTRACT

A social networking communication system of the type for exchanging messages among cellular telephone users without requiring the users to divulge their cellular telephone numbers to one another, the improvement comprising of collecting and recording personal information, to sign up cellular telephone users, and providing a docking system adapted to facilitate entry by at least one user of a code to the system advising it that they are present at the particular facility. Users can send messages to other users docked at the facility without requiring them to reveal their identity. Messages may be generated by the system to docked users advising them of other docked users and/or information related to said uses. Advertisements may be targeted to docked users based on their user profile information.

### RELATED APPLICATIONS

None.

### BACKGROUND

A. Field of the Invention

The invention relates to communication systems for exchanging messages. More particularly, the invention relates to a facility-based system for allowing users to send and receive messages of interest based on the characteristics of the facility itself and based on the known characteristics of users present at a facility.

B. Related Art

Social networking systems typically allow users to create unique personal profiles that include information about the user such as their name, interests, profession, relationship status, and information about their wider social network. Users can indicate their relationship with other users, either by inviting other members to join their network (e.g., Myspace®, Facebook®, Friendster® and Linkedin®), or by using software to scan existing relationships recorded in computer contact software (e.g., Spoke® and Visible Path®). Typically, connections are facilitated by sending messages (such as instant messages or emails via the Internet) to friends who are already known or directly to people the user has an interest in establishing a connection with. Other connections can be made through linking chains of existing relationships of people who may or may not be known to the user (a “friend of a friend” and so on). These systems have traditionally been implemented via the Internet in a computer-based environment.

The same types of systems have begun to be established in a mobile social networking environment, usually implemented via the cellular telephones, though they could also work with other mobile communication devices, such as game consoles, I-pods® and the like. These mobile systems provide such functions as friend-finding, text-dating and community message aggregation. Friend-finder applications (e.g., Dodgeball) announce connections in a user's “relationship map,” which can identify the location of the user or the friend. Such applications may also consult the relationship map and identify “friends of friends” who have announced they are within a certain range of the user's vicinity. The user indicates their location by typing an address, an intersection, or the like. For instance, on Dodgeball, you send a message to a specified number indicating that you are “@ ace bar.” Dodgeball responds with a possible location, assuming that you are in your home city. For example, it would send back the name of the bar the system believes you may be referencing with an address for that facility at which point a user either confirms that is the location they are referencing or re-starts the facility identification dialog. To indicate their presence in a different city than their home city, Dodgeball users have to access their account via the Internet to change the location set for them by the Dodgeball system or send a mobile message identifying the new city. They then have to identify, in a subsequent message, a facility within that city where they are present. The system only works in cities for which it has been set up, at the time of this writing, only 22 cities.

Text-dating applications (e.g., MobiVibe®) allow users to connect with new friends who meet age and gender criteria, enabling users to communicate, e.g., to exchange text messages. Community message aggregators (e.g., Upoc®) distribute messages from one member to all members within a specific community. In an illustrative service, one member may identify a famous person or celebrity and a message about the person or celebrity is communicated to all community members. In Dodgeball, a user can indicate a desire to send a specified message to all of their “friends” by putting an exclamation point at the start of a message. This broadcast-type message allows a user to announce a party or the like.

Though these mobile systems have typically used the short message system (“SMS”) protocol, they could also work with multimedia messaging service (“MMS”) or other similar protocols. Further, cellular telephones with Internet connections may facilitate communication via Internet-based instant messages, behaving much like personal computers in this respect. Newer phones also often use wireless networking (often referred to as “Wi-Fi”) to communicate. Wi-Fi communications are typically transmitted to a wireless router, then translated onto the wired Internet. Any of these wireless communication methods may be adapted to be used for a mobile social networking system.

Some of the current social networking systems provide an open application program interface (“API”). An open API enables development of third-party software to interact with the system in predictable ways. For example, Facebook offers an open API, and it describes this interface as follows: “The Facebook API uses a REST-based interface. This means that our Facebook method calls are made over the internet by sending HTTP GET or POST requests to our REST server. With the API, you can add social context to your application by utilizing profile, friend, photo, and event data.” Facebook and similar profiles provide a rich level o personalized information about their users that may be accessed via this open API. Thus, the personal details provided by Facebook users can be accessed by third-party software developers.

These Internet or mobile systems may use online search engines to mine public sources of data, for instance the Internet's World Wide Web (WWW), for professional history information and contact details. In a different field, the recruitment industry (e.g., Eliyon) uses such business professional databases to find candidates for job positions. Eliyon scans news articles, press releases and corporate web sites on the Internet, extracts specific information about people and companies, and then organizes the information into a database of separate profiles for possible job candidates. Individual profiles include current employment, past employment, educational background, company information and links to the web pages from which information was collected. However, due to the fact that many people have the same or similar names, Eliyon is subject to mis-identifying persons or associating inaccurate information with them.

### SUMMARY OF THE INVENTION

The present invention comprises a social networking communication system for the type of exchanging messages among mobile device users without requiring the users to divulge their actual identifying information (e.g., cellular telephone numbers) to one another. The Invention incorporates the ability to find background information on users from social Internet web page cites having an open API. The invention also provides the ability to create and describe, with detailed information, facilities at which users can gather. Facility-specific information can also be gleaned from specified web sites. In addition, the invention includes the ability to create targeted advertising or other messages to users based on their personal information as compared to information about other uses or as compared to information about the facility itself.

There have thus been outlined, rather broadly, the more important features of the invention in order that the detailed description thereof that follows may be better understood, and in order that the present contribution to the art may be better appreciated. There are, of course; additional features of the invention that will be described hereinafter and which will form the subject matter of the claims appended hereto.

In this respect, before explaining at least one embodiment of the invention in detail, it is to be understood that the invention is not limited in this application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present, invention. Additional benefits and advantages of the present invention will become apparent in those skilled in the art to which the present invention relates from the subsequent description of the preferred embodiment and the appended claims, taken in conjunction with the accompanying drawings. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention of the application which is measured by the claims, nor is it intended to be limiting as to the scope of the invention in any way.

### BRIEF DESCRIPTION OF THE DRAWINGS

FIG. 1 is a flow chart showing the user activation protocol to create a record for the user.

FIG. 2 is a flow chart of the facility activation protocol which allows for the creation and description of a facility at which users can gather.

FIG. 3 is a flow chart showing the user docking protocol.

FIG. 4 is a flow chart showing mining of data from external servers and comparison of that data to other users or the facility itself to generate messages targeted to activated users at a facility.

FIG. 5 describes message flow among activated users at a facility and between the users and the system itself.

FIG. 6 describes real time activation of a user.

FIG. 7 is a schematic diagram showing various devices associated with the system and their communication via wireless communication network and a communication network such as the Internet.

### DETAILED DESCRIPTION

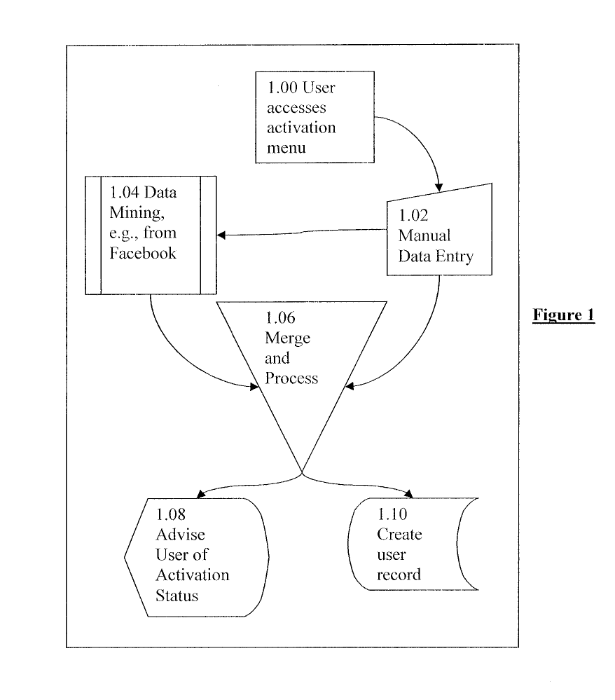

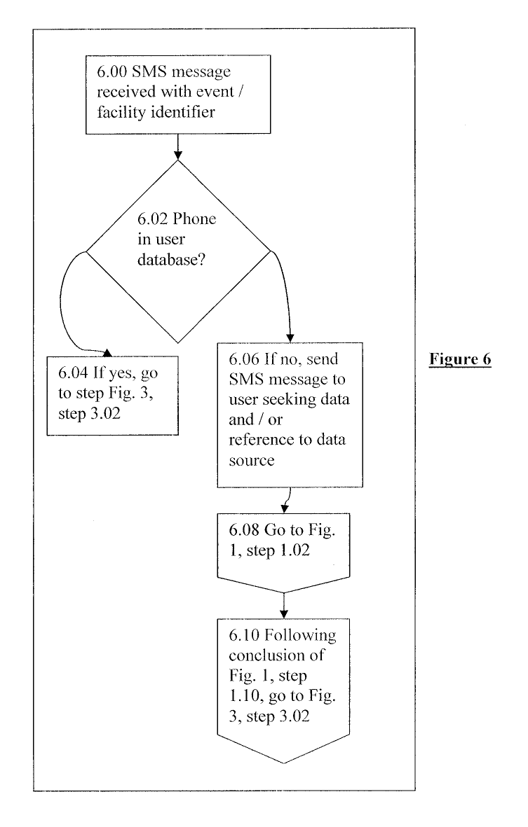

FIG. 1 shows user activation protocol. In step 1.00, a prospective user accesses the activation menu. This may be done by a user calling a designated telephone number and doing the activation by voice, by a user accessing a web site operating in conjunction with the system to activate their protocol, by traditional mail, by e-mail, or even real-time activation from a cellular telephone or similar communication device. Real-time activation of the system is illustrated in FIG. 6.

By whatever method the user accesses the activation menu at 1.00, they can then manually identify data to be associated with their account in step 1.02. During this manual data entry step, 1.02, they can also reference an external server from which to mine data in step 1.04. For example, a user could identify that they have a Facebook account, give the user name and password for the account, allowing the system to go to the open API for Facebook and mine data applicable to the user. The data to be entered could include the users real name, address, e-mail, phone numbers, job, dating or marital status, age, sex, and any other information that may be used to determine relevant characteristics of the user.

The data either manually entered or manually provided or mine from external servers in steps 1.02 and 1.04 is merged and processed in step 1.06. Once the merging and processing is done, the system, in step 1.10 creates a user record, which is maintained in a storage server 7.11. The system may also, in step 1.08, advise the user of the activation status. Preferably, the terms of service provide that submitting a request for service binds the user to the applicable service terms.

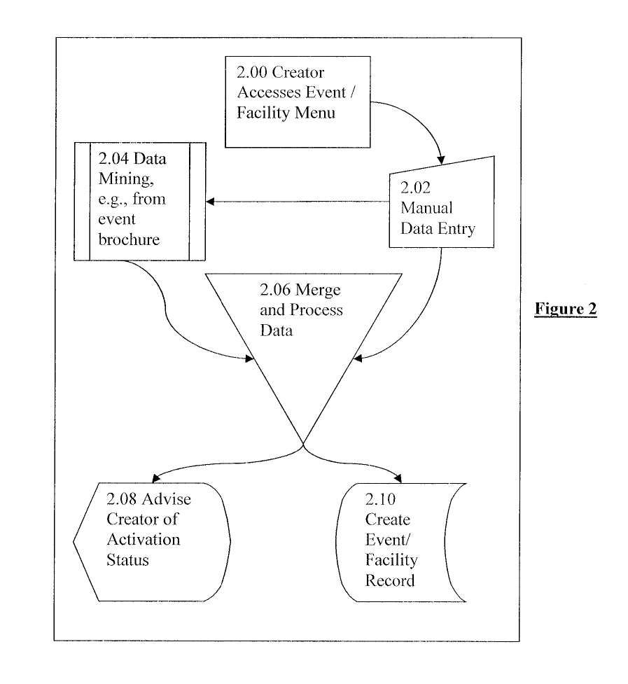

FIG. 2 shows the facility activation protocol. In step 2.00, a creator, who is a person or entity desiring to set up a facility at which users can gather, accesses is the event/facility menu in step 2.00. At that time, like a user setting up their account, the person “creating” a facility can manually enter data in step 2.02. During the manual data entry step, they can identify an external server or source of information which data could be mined. If such an external server or source is identified in step 2.02, that data is mined in step 2.04. Typically, this may be, for example, from a brochure describing the event and its characteristics. The data entered manually and mined from external servers or sources is then merged and processed in step 2.06. In stages of merging and processing, in step 2.10, the system creates and event/facility record with information about the event's location, its characteristics, such as the targeted type of professionals which may attend or the type of facility it is (for example, a bar typically serving those from 18 to 30). The system may advise the creator of the activation status for the facility in step 2.08.

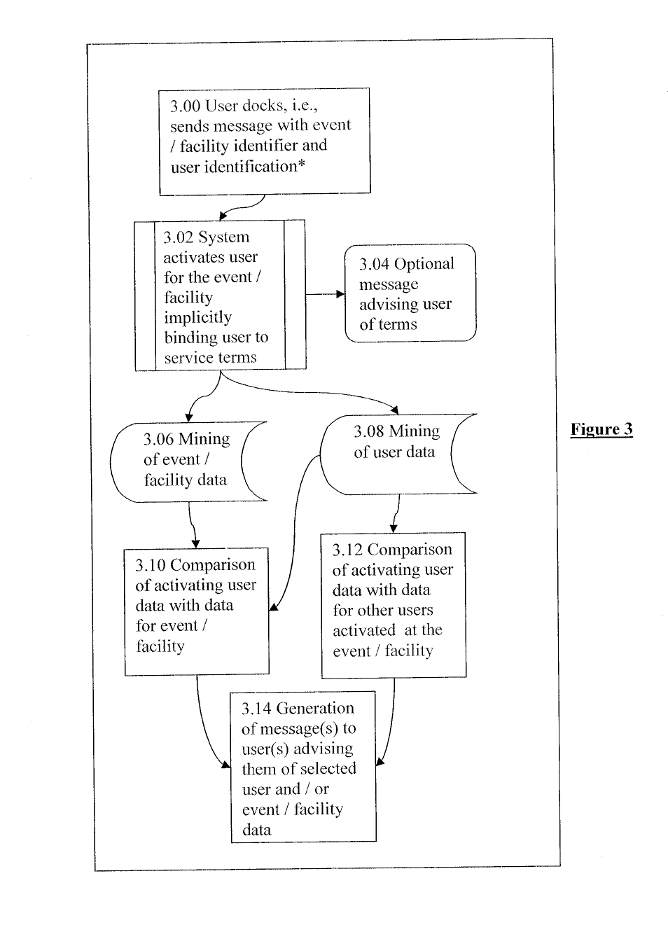

In FIG. 3, a user docks with the system in step 3.00. Docking typically is accomplished by sending a message with an identifier associated with the facility and the user's identification. The user's identification is typically not entered by the user, but rather is, for example; the cellular telephone number associated with the mobile device he is using. Other types of devices will also have identifiers (for example, on the Internet, each device has a unique IP address). The facility identifier may be known to the user, or it may be a description of the facility's name, such as that used in the Dodgeball system where you simply type, for example, “Ace Bar.” Preferably, however, the present system uses a unique facility identifier code which is either known to user or presented by the facility on-site. That is, there could be a sign when you enter the facility that shows the facility code. It could also be presented on the materials distributed at, for example, a business seminar. If a user has pre-registered for an event at a facility, they may receive at or near the time of the event to occur a message from the system advising them of the facility code and either allowing them to specifically enter that code at a subsequent time or to respond with an accept message indicating that they are at the facility. Once the user sends the event/facility identifier, in step 3.02, the system activates the user for the facility, again either expressly or implicitly binding the user to the service terms. In step 3.04, there may be an optional message sent to the user advising them of the specific terms applicable to that facility or generally applicable to the system.

Once the user has been activated in step 3.02, the system may mine the facility data in step 3.06 and then in step 3.10, compare the data for the activating user with the data for the event/facility. Based on this comparison of the information for the user of the facility, in step 3.14, the system may generate at least one message to at least one activated user advising them of other users activated at the facility or characteristics about the facility or advertisements offering goods or services with or through the facility. These advertisements may also be sent on behalf of third parties either approved by the facility or by the operator of the system. At a business seminar happening in a hotel, the sponsor of the seminar may allow vendors, who sell goods or services to the type of persons attending the seminar, to access information on docked users and create advertisements to those users for payment of a fee. In step 3.08, after mining user data, that data may be compared in step 3.12 to other users activated at the facility for the generation of messages in step 3.14.

In step 3.10, the comparison of user data to other users may generate messages indicating common characteristics of users activated at the facility. If, for example, there are a number of information managers present at a facility, each of the persons having that characteristic may be notified with a listing of the common characteristics they have with other users at the facility and advising them of at least a pseudonym for those users allowing intercommunication of the users receiving said message.

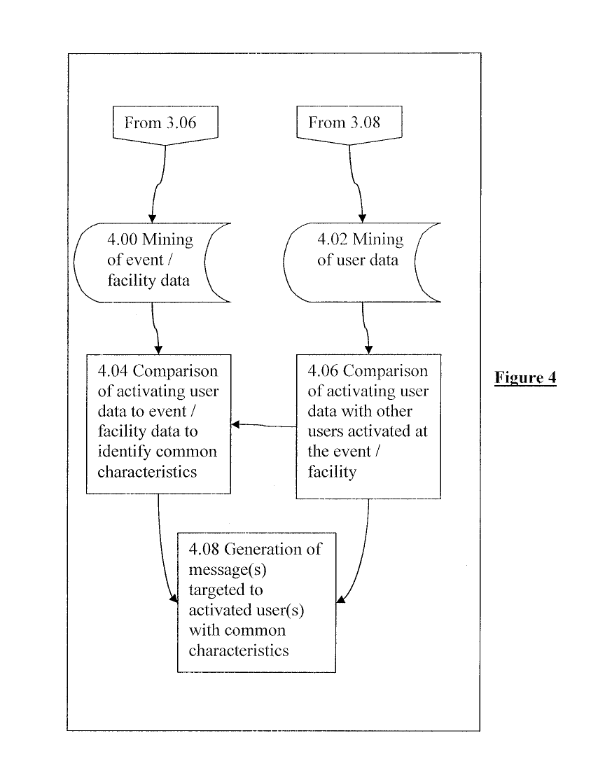

FIG. 4 illustrates a variation of data collection in more detail. Specifically, in FIG. 3, there is a step where user data is mined. In FIG. 4, this is shown as step 4.00 regarding mining of an event/facility data and 4.02 regarding mining of user. These two data sets are then, used to compare the common characteristics of activated users with facility data to create in steps 4.04 and 4.06 to generate messages targeted to activated users with common characteristics. For example, if at a facility there are 5 doctors with a particular speciality, the facility could generate a message to them advising them of some sort of special, a travel special or subsequent seminar at a facility more targeted to their sub-speciality. This generation of messages targeted to activated users common characteristics in step 4.08 is useful because it allows for the system to generate revenue associated with advertising. That is, facilities may want to target users based on the known characteristics of the users and the facilities can be billed for such data mining capacities and for the generation of the messages targeted to users at facilities.

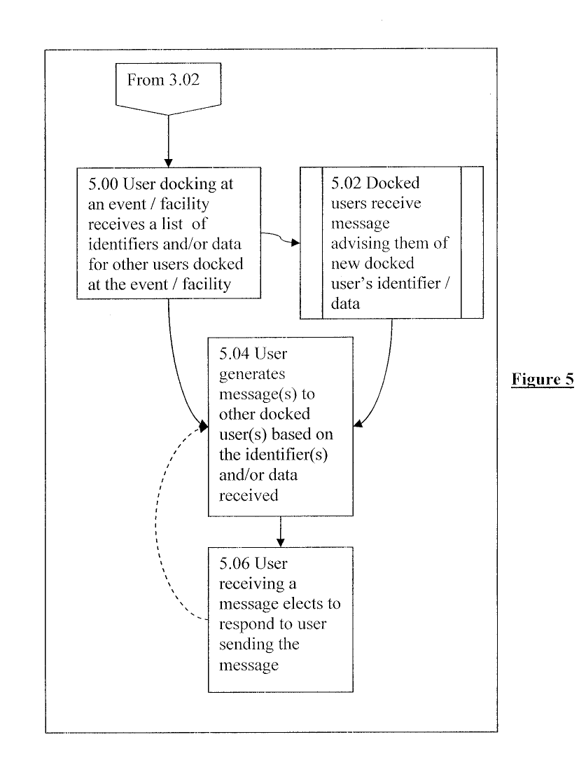

FIG. 5 illustrates the communication among users at a facility. The starting point is step 3.02 after a user docks at with a facility. In step 5.00, user docking at an event or facility receives a list of identifiers and/or data for other users docked at the event or facility. This list can be comprised simply of a list of pseudonyms for docked users. The system can either allow for revelation of the actual, for example, cell phones, numbers of users docked at a facility or it can provide for pseudonyms for those users. These pseudonyms facilitate exchange of messages among dock users without requiring the actual identifier, such as a cell phone number, to be revealed. The information provided in step 5.00 could also identify persons at the facility meeting the criteria specified by the activating user. An activating user might desire to know about other professionals at the facility having the same speciality as him or her. The list provided in step 5.00 could provide that kind of information to the user. It could also provide dating-type information such as single persons of the opposite sex within a range of characteristics specified by the activated user, if, for example, the facility is a bar. At or around the same time, as step 5.02 is performed, previously docked users may receive a message advising them of the new dock users identifier and/or data. The same kind of information can be provided to previously docked users as is provided to newly docking users. Based on the information provided to the newly docking and previously docked users in steps 5.00 and 5.02, at step 5.04, users can generate a message to other dock users based on the identifiers or information received. As with the Dodgeball system, these responses can be a message that is indicated to respond to all users docked at the facility or can be targeted to specific identified users. The docked users receiving a message can, in step 5.06, then respond to the user sending the original message and communications can continue with messages back and forth among users as they see fit.

As noted in discussing FIG. 1, above, users can activate themselves with the system at any time. This may most conveniently be done via computer with internet access so that keystrokes and typing are faster and more accurate. However, it is possible that a user may attend a facility and see an identifier indicating the facility is activated in this system. At that point, the user may want to activate a new account. In step 6.00 of FIG. 6, a user desiring to activate sends a message to the system. This may be an SMS message, which is commonly referred to as a text message sent via cellular phone. The message needs to include the facility identifier, and the message itself, only if it is sent by cell phone, will include the cell phone number of the user. In step 6.02, the system determines whether the phone number or other identifier for the user is in the database of activated users. If it is, at step 6.04, the system then goes to FIG. 3, step 3.02. However, if in step 6.02 it is determined that the user is not in the database of previously activated users, a message is sent back to the user seeking data and/or reference to external sources of data necessary to activate them. These steps continue via messages back and forth between the system and the user seeking to activate until specific information is provided to the system that it can activate the user as generally described in FIG. 1, above. Thereafter, at steps 6.08, the system goes to step 1.02, in following the conclusion of data entry in step 6.10, system goes to FIG. 3, where the user is activated for the facility at issue. The new user is then docked and can use the system as indicated previously.

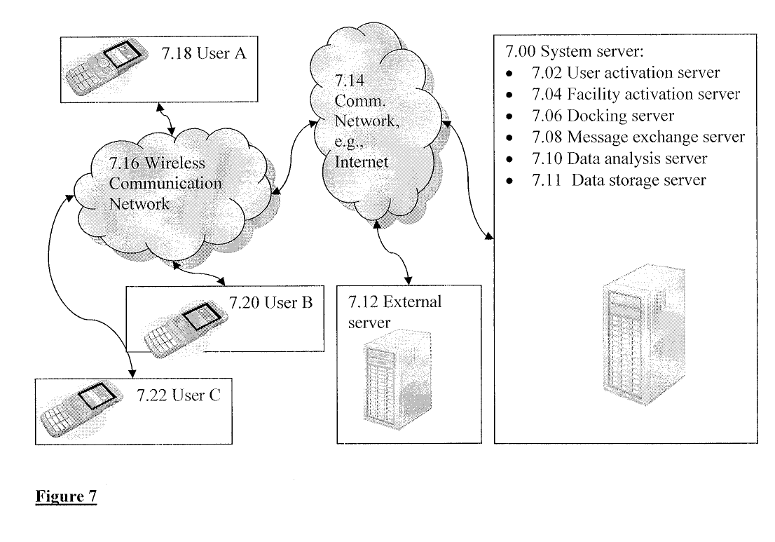

FIG. 7 shows a stylized schematic of the system. The system server 7.00 includes several components: 7.02 is a user activation server; 7.04 is a facility activation server; 7.06 is a docking server; 7.08 is a message exchange server; 7.10 is a data analysis server, and 7.11 is a storage server. These various servers may be physically included with a single computer system, or they may be a distributed computer system. The system server can communicate externally through a communication network 7.14. The communication is preferably the Internet, but it also could communicate via a VPN or other type of network. Via communication through the network 7.14, the system server, 7.00 can communicate with at least one external server 7.12. This external server could, for example, be a server for a social networking site such as Facebook, Myspace or the like. Via an interlink, the communication network 7.14 may be in communication with a wireless communication network 7.16. This wireless communication network is preferably the cellular telephone network. The plurality of users have access via their wireless devises to the wireless communication network 7.16. As shown, there are 3 users, users A, B and C, or 7.18, 7.20 and 7.22, respectively. When, in FIG. 3, a user sends a message to the system, indicating a desire to dock at a particular facility. That message is first communicated from his device 7.18 to the wireless communication network 7.16. From there, via interlink it is communicated to the communication network 7.14. Thereafter, that communication travels to the system server 7.00. Alternatively, the system server may have a wireless communication link module that communicates directly with the wireless communication network 7.16. This wireless communication link module would send either SMS-type or MMS-type messages through the wireless communication network to activated users.

There have thus been outlined, rather broadly, the more important features of the invention in order that the detailed description thereof that follows may be better understood; and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in this application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such; those skilled in the art will appreciate that the conception, upon which this disclosure is based, may readily be utilized as a basis for the designing of other structures, methods and systems for carrying out the several purposes of the present invention. Additional benefits and advantages of the present invention will become apparent in those skilled in the art to which the present invention relates from the subsequent description of the preferred embodiment and the appended claims; taken in conjunction with the accompanying drawings. It is important, therefore, that the claims be regarded as including such equivalent constructions insofar as they do not depart from the spirit and scope of the present invention.

Further, the purpose of the foregoing abstract is to enable the U.S. Patent and Trademark. Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention of the application which is measured by the claims, nor is it intended to be limiting as to the scope of the invention in any way.

While the invention has been shown, illustrated, described and disclosed in terms of specific embodiments or modifications, the scope of the invention should not be deemed to be limited by the precise embodiment or modification therein shown, illustrated, described or disclosed. Such other embodiments or modifications are intended to be reserved especially as they fall within the scope of the claims herein appended.

Having thus described the invention, I claim:

1. A social networking communication system of the type for exchanging messages among cellular telephone users without requiring the users to divulge their cellular telephone numbers to one another, the improvement comprising:
a. collecting and recording personal information to sign up cellular telephone users;
b. providing a docking system adapted to facilitate entry by at least one user of a code to the system advising it that they are present at the particular facility.

2. The social networking communication system of claim 1 adding the step of the facility generating advertising messages targeted to at least one docked user based on the recorded personal information.

3. The social networking communication system of claim 1, the system further adapted to gather information on the facility, the system then using that information in generating, on behalf of the facility, messages targeted to docked users based on the recorded personal information compared to the information gathered on the facility.

4. The social networking communication system of claim 3, the system further adapted to gather information from at least one external database from which the system can mine data relevant to the facility.

5. The social networking communication system of claim 1, the step of collecting and recording personal information proving a data collection means for users to reference at least one external database from which the system can mine personal information for the user.

6. The social networking communication system of claim 5, the external database comprising at least one specific Internet-based social networking site.

7. The social networking communication system of claim 6, the system personal information retrieved including at least one group of persons known to the user.

8. The social networking communication system of claim 1, the code for indicating presence a the facility being changeable and only displayed at the facility to prevent users from falsely registering their presence at the facility.

9. A social networking communication system of the type for exchanging messages among cellular telephone users without requiring the users to divulge their cellular telephone numbers to one another, the improvement comprising:
a. collecting and recording personal information from cellular telephone users including allowing users to reference at least one external database from which the system can mine personal information for the user;
b. providing a docking system adapted to facilitate entry by users of a code to the system advising it that they are present at a particular facility; and
c. generating advertising messages targeted to at least one docked user based on the recorded personal information.

10. The social networking communication system of claim 9, the system further adapted to gather information on the facility, the system then using that information in generating, on behalf of the facility, messages targeted to at least one docked user based on the recorded personal information compared to the information gathered on the facility.

11. The social networking communication system of claim 9, the system further adapted to gather information from at least one external database from which the system can mine data relevant to the facility.

12. A communication system comprising:
a. a communication network for exchanging messages via electromagnetic transmissions;
b. a user activation protocol adapted to gather and store information related to users with access to a communication device capable of communicating via the network;
c. a facility activation protocol adapted to gather and store information related to facilities which will serve as a point for users to gather;
d. a docking protocol adapted to allow a user to register their presence at a facility;
e. a message exchange protocol adapted to transmit messages among at least two users activated at a facility without requiring revelation of each user's identity.

13. The communication system of claim 12 further comprising:
a. a user data analysis protocol for comparing information related to at least two users activated at a facility to identify similarities; and
b. a message generation protocol for generating messages to at least one activated user with data about at least one other activated user.

14. The communication system of claim 12 further comprising:
a. a facility data analysis protocol for comparing information related to at least one user activated at a facility to information about the facility itself; and
b. a message generation protocol for generating messages to at least one user activated at the facility based on identified similarities between the user and the facility.

15. The communication system of claim 12, the user activation protocol adapted to receive access information for retrieving data from at least one external server.

16. The communication system of claim 12, the facility activation protocol adapted to receive access information for retrieving data from at least one external server.

17. The communication system of claim 12, the user activation protocol adapted to facilitate on-site activation via messaging at the time a user enters a facility, the on-site activation comprising the steps of
a. receiving a message from a prospective user;
b. determining, based on an identifier associated with the user's communication device that the user has not previously provided information to the system;
c. generating a message to the user with instructions on information needed to allow him to use the system;
d. receiving at least one responsive communication from the user providing the information needed to allow him to use the system; and
e. activating the user after the needed information is verified.

18. The communication system of claim 12, the facility activation protocol adapted to allow facility activation via messages comprising the steps of
a. receiving a message from a user indicating a desire to activate a facility;
b. generating a message to the user with instructions on information needed to activate the facility;
c. receiving at least one responsive message from the user providing the information needed to activate the facility; and
activating the facility after the needed information is verified.

19. The communication system of claim 18, further providing the following step: receiving from the user a message identifying at least one other user to be advised of the activation of the facility.

20. The communication system of claim 19, the user advising the facility of a group of users to be notified.

21. The communication system of claim 20 where the group is a list of persons known to the user, information on the group having been mined from an external server.

22. A communication system comprising:
a. a user activation protocol adapted to gather and store information related to users with access to a communication device capable of communicating via the network;
b. a facility activation protocol adapted to gather and store information related to facilities which will serve as a point for users to gather;
c. a facility activation protocol adapted to gather and store information related to facilities which will serve as a point for users to gather;
d. a docking protocol adapted to allow a user to register their presence at an activated facility;
e. a message exchange protocol adapted to transmit messages among at least two users activated at a facility without requiring revelation of each user's identity;
f. a data analysis protocol for comparing information related to at least one user activated at a facility and information about the facility itself to identify similarities; and
g. a message generation protocol for generating messages to at least one user activated at a facility based on identified similarities among users and the facility.

23. The communication system of claim 22, the user activation protocol adapted to receive access information for retrieving data from at least one external server accessible via a communication network.

24. The communication system of claim 22, the facility activation protocol adapted to receive access information for retrieving data from at least one external server accessible via a communication network.

25. The communication system of claim 22, the user activation protocol adapted to facilitate on-site activation via messages at the time a user enters a facility, the on-site activation comprising the steps of:
a. determining, based on the identifier associated with the user's communication device that the user has not previously provided information to the system;
b. generating a message to the user with instructions on information needed to allow him to use the system;
c. receiving at least one responsive communication from the user providing the information needed to allow him to use the system; and
d. activating the user after the needed information is verified.
